(19) United States
(12) Patent Application Publication
(10) Pub. No.: US 2010/0214323 A1
(43) Pub. Date: Aug. 26, 2010

(54) IMAGE PROCESSING SYSTEM, IMAGE PROCESSING APPARATUS, DISPLAY APPARATUS, METHOD OF CONTROLLING THE SAME, AND PROGRAM

(75) Inventor: Tsutomu Sakaue, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/706,588

(22) Filed: Feb. 16, 2010

(30) Foreign Application Priority Data
Feb. 23, 2009 (JP) 2009-039833

(51) Int. Cl. G09G 5/00; G06F 3/12

(52) U.S. Cl. 345/661; 345/619; 358/1.15

(57) ABSTRACT

This invention provides a mechanism that enables to use history information representing the history of a predetermined operation performed by an operator during a presentation without shooting it by a video camera or the like. To accomplish this, an image processing system stores, as history information, user operations such as pointer manipulation and an enlargement rendering operation at the time of presentation on the display apparatus together with the operation target display area. An image processing apparatus creates the digest data of the presentation using the history information and display data used for the presentation.

### BACKGROUND OF THE INVENTION

1. Field of the Invention

The present invention relates to an image processing system formed by connecting a display apparatus to an image processing apparatus, the image processing apparatus, the display apparatus, a method of controlling the same, and a program.

2. Description of the Related Art

There is a technique of recording a presentation made at a lecture using a display apparatus such as a projector, thereby generating a multimedia content of the presentation. Japanese Patent Laid-Open No. 2005-252574 proposes an apparatus which generates multimedia content of a presentation based on the video information of a presenter shot by a video camera and screen information output from the presentation practicing terminal and displayed on a projector or the like. More specifically, a presentation is made in front of a video camera or the like, and the shot video is synchronized with presentation data, thereby automatically generating content.

However, the prior art has the following problems. For example, when making a presentation using a projector, although it is possible to record presentation materials projected by the projector, pointer movement information or enlargement rendering for a description cannot be recorded as a history. To record these pieces of information, it is necessary to shoot the presentation itself using a video camera or the like and contrast the shot history with the presentation materials once more. For the contrast, the video shot by the video camera needs to be played back and confirmed. This operation requires an enormous time and labor.

That is, the technique described in Japanese Patent Laid-Open No. 2005-252574 needs shooting by a video camera and therefore lacks simplicity. In addition, the technique described in Japanese Patent Laid-Open No. 2005-252574 generates content by synchronizing a shot video with presentation data but does not record the presentation history. To generate content by recording portions emphasized or points pointed by the presenter (operator) during the presentation, the prior art requires cumbersome operations for preparation for presentation recording and for actual recording.

### SUMMARY OF THE INVENTION

The present invention enables realization of a mechanism for enabling utilization of history information representing the history of a predetermined operation performed by an operator during a presentation without shooting it by a video camera or the like.

One aspect of the present invention provides an image processing system formed by connecting a display apparatus to an image processing apparatus, the display apparatus comprising: a display unit that receives display data sent from the image processing apparatus and displays a display image based on the display data; a specifying unit that specifies an operation to the display apparatus performed by an operator during display of the display image; and a storage unit that stores history information representing a history of the specified operation, and the image processing apparatus comprising: a generation unit that generates the display data to be sent to the display apparatus; and a memory unit that, after the generated display data has been sent to the display apparatus, receives the history information from the display apparatus and memorizes the received history information in correspondence with the generated display data.

Another aspect of the present invention provides an image processing apparatus connected to a display apparatus, comprising: a generation unit that generates display data to be sent to the display apparatus; and a creation unit that receives, from the display apparatus, history information representing a history of an operation to the display apparatus performed by an operator during display of a display image displayed by the display apparatus based on the display data, and creates, using the display data and the history information, digest data of a presentation made by the operator using the display image.

Still another aspect of the present invention provides a display apparatus connected to an image processing apparatus, comprising: a display unit that receives display data sent from the image processing apparatus and displays a display image based on the display data; a specifying unit that specifies an operation to the display apparatus performed by an operator during display of the display image; and a sending unit that sends, to the image processing apparatus, history information representing a history of the specified operation.

Yet still another aspect of the present invention provides a method of controlling an image processing system formed by connecting a display apparatus to an image processing apparatus, comprising: causing the display apparatus to execute receiving display data sent from the image processing apparatus and displaying a display image based on the display data, specifying an operation to the display apparatus performed by an operator during display of the display image, and storing history information representing a history of the specified operation; and causing the image processing apparatus to execute generating the display data to be sent to the display apparatus, and after the generated display data has been sent to the display apparatus, receiving the history information from the display apparatus and memorizing the history information in correspondence with the generated display data.

Still yet another aspect of the present invention provides a method of controlling an image processing apparatus connected to a display apparatus, comprising: generating display data to be sent to the display apparatus; and receiving, from the display apparatus, history information representing a history of an operation to the display apparatus performed by an operator during display of a display image displayed by the display apparatus based on the display data, and creating, using the display data and the history information, digest data of a presentation made by the operator using the display image.

Yet still another aspect of the present invention provides a method of controlling a display apparatus connected to an image processing apparatus, comprising: receiving display data sent from the image processing apparatus and displaying a display image based on the display data; specifying an operation to the display apparatus performed by an operator during display of the display image; and sending, to the image processing apparatus, history information representing a history of the specified predetermined operation.

Still yet another aspect of the present invention provides a computer-readable storage medium storing a computer program which causes a computer to execute the image processing system control method.

Yet still another aspect of the present invention provides a computer-readable storage medium storing a computer program which causes a computer to execute the image processing apparatus control method.

Still yet another aspect of the present invention provides a computer-readable storage medium storing a computer program which causes a computer to execute the display apparatus control method.

Further features of the present invention will be apparent from the following description of exemplary embodiments with reference to the attached drawings.

### BRIEF DESCRIPTION OF THE DRAWINGS

FIG. 1 is a view showing an example of the arrangement of an image processing system according to the first embodiment;

FIG. 2 is a block diagram showing an example of the arrangement of a printing apparatus 100 according to the first embodiment;

FIG. 3 is a block diagram showing an example of the arrangement of a projector 120 according to the first embodiment;

FIG. 4 is a flowchart illustrating a display list generation procedure according to the first embodiment;

FIG. 5 is a sequence chart showing communication between the printing apparatus 100 and the projector 120 according to the first embodiment;

FIG. 6 is a view showing a display image 600 obtained by outputting display data according to the first embodiment;

FIG. 7 is a sequence chart showing the procedure of creating digest data of a presentation according to the first embodiment;

FIG. 8 is a view showing digest images 1000 and 1100 of a presentation according to the first embodiment; and

FIG. 9 is a view showing the structure of a display image according to the second embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### Arrangement of Image Processing System

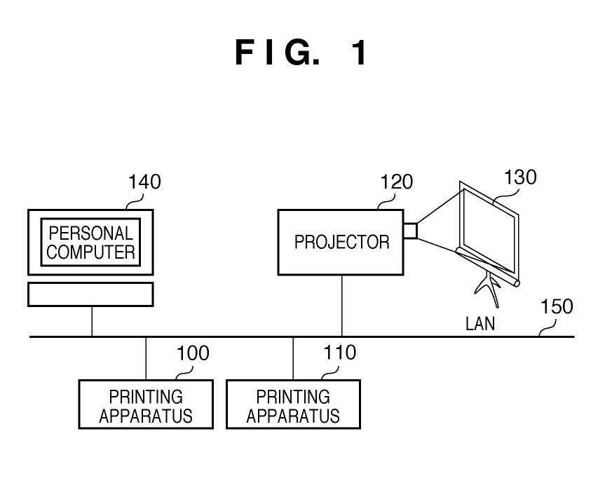

The first embodiment will now be described with reference to FIGS. 1 to 8. FIG. 1 is a view showing an example of the arrangement of an image processing system according to the first embodiment. Note that as an image processing apparatus include din the image processing system, a printing apparatus will be exemplified in FIG. 1. However, the present invention is applicable not only to a printing apparatus but also to any other image processing apparatus such as a copying machine or a facsimile apparatus. A projector for projecting a display image on a screen or a wall will be exemplified as a display apparatus. However, it may be an apparatus for displaying a display image using a monitor or the like.

In the image processing system shown in FIG. 1, a personal computer 140, two printing apparatuses 100 and 110, and a projector 120 serving as a display apparatus are connected to a LAN 150. Reference numeral 130 denotes a screen on which the projector 120 projects an irradiation image. In the image processing system according to the present invention, the number of connected devices is not limited to that in FIG. 1. The LAN 150 is applied here as a connection method. However, the present invention is not limited to this. For example, an arbitrary network such as a WAN (public network), a serial transmission scheme such as a USB, or a parallel transmission scheme such as centronics or SCSI is also applicable. The projector 120 outputs an irradiation image to the screen 130.

The personal computer (to be referred to as a PC hereinafter) 140 has the functions of a general personal computer. The PC 140 can send or receive a file or email using the FTP or SMB protocol via the LAN 150 or a WAN. The PC 140 can also send a print instruction to the printing apparatuses 100 and 110 via a printer driver.

According to the embodiment, when the image processing system is used for a presentation, the projector 120 stores history information of predetermined operations performed by the presenter (operator) during the presentation. Additionally, in the image processing system, the printing apparatus 100 or 110 creates the digest data (digest version) of the presentation using the stored history information of predetermined operations and display data during the presentation. In the embodiment, an example will be described in which operations associated with portions the operator have emphasized during the presentation, such as the movement of the pointer manipulated by the operator and an enlargement rendering operation for part of a display image, are added to digest data as predetermined operations.

<Arrangement of Printing Apparatus>

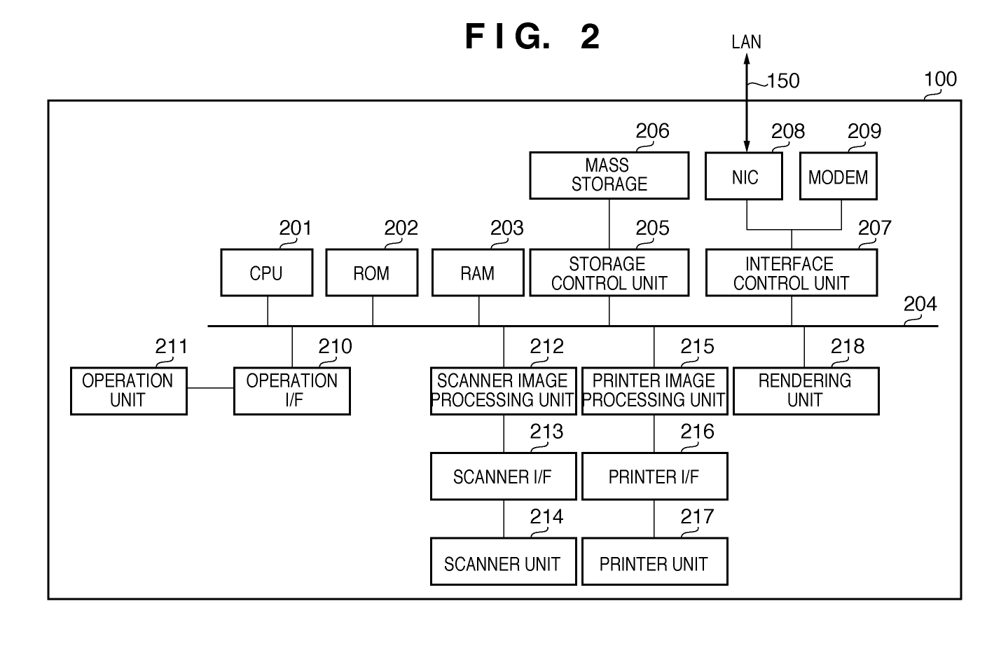

The arrangement of the printing apparatus 100 or 110 of this embodiment will be described next with reference to FIG. 2. FIG. 2 is a block diagram showing an example of the arrangement of the printing apparatus 100 according to the first embodiment. The printing apparatus 110 has the same arrangement as that of the printing apparatus 100 to be explained below, and a description thereof will be omitted.

The printing apparatus 100 includes a CPU 201, ROM 202, RAM 203, storage control unit 205, mass storage 206, interface control unit 207, NIC 208, modem 209, operation I/F 210, operation unit 211, scanner image processing unit 212, scanner I/F 213, scanner unit 214, printer image processing unit 215, printer I/F 216, printer unit 217, and rendering unit 218. These blocks are connected via a data bus 204 to enable data communication with each other.

The CPU 201 is a controller configured to control the overall printing apparatus 100. The CPU 201 runs the OS (Operating System) based on a boot program stored in the ROM 202. A controller program and various kinds of application programs stored in the mass storage 206 run on the OS. The RAM 203 serves as a temporary storage area such as the main memory or work area of the CPU 201. The RAM 203 is also used as a temporary storage area for image processing.

The interface control unit 207 controls a network I/F such as the NIC (Network Interface Card) 208 to send/receive various data such as image data to/from a network such as the LAN 150. The interface control unit 207 also controls the modem 209 to send/receive data to/from a telephone line.

The operation I/F 210 inputs a user's operation instruction from the operation unit 211 such as a touch panel or a hard key. The operation I/F 210 also controls the operation unit 211 such as an LCD or a CRT to display an operation window for the user.

The scanner image processing unit 212 corrects, manipulates, and edits image data received from the scanner unit 214 via the scanner I/F 213. Note that the scanner image processing unit 212 determines whether the received image data is, e.g., a color original or a monochrome original, or a character original or a photo original. The determination results are added to the image data. The additional information will be referred to as attribute data hereinafter.

The printer image processing unit 215 performs image processing for print output, thereby generating bitmap data. The printer image processing unit 215 then sends the bitmap data to the printer unit 217 via the printer I/F 216. The printer unit 217 executes print processing for a printing material such as a paper sheet in accordance with the received bitmap data output via the printer I/F 216.

The rendering unit 218 generates bitmap data representing a print image. Print data sent from the PC 140 is input to the printing apparatus 100 via the LAN 150. The input print data is converted into a display list by the CPU 201 and then sent to the rendering unit 218. The rendering unit 218 interprets the display list data converted by the CPU 201, thereby generating bitmap data.

<Arrangement of Projector>

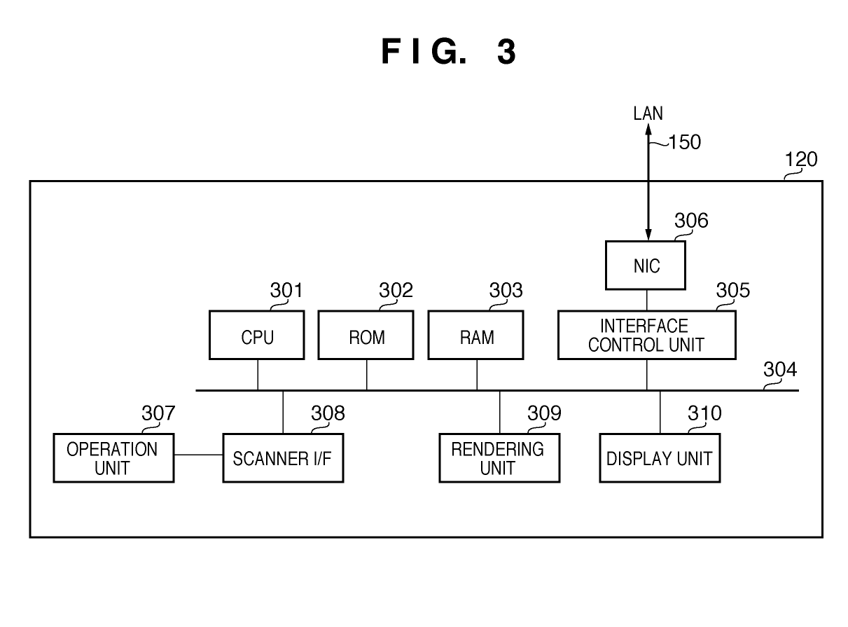

The arrangement of the projector of this embodiment will be explained next with reference to FIG. 3. FIG. 3 is a block diagram showing an example of the arrangement of the projector 120 according to the first embodiment.

The projector 120 includes a CPU 301, ROM 302, RAM 303, interface control unit 305, NIC 306, operation unit 307, operation I/F 308, rendering unit 309, and display unit 310. These blocks are connected via a data bus 304 to enable data communication with each other.

The CPU 301 is a controller configured to control the overall projector 120. The CPU 301 runs the OS (Operating System) based on a boot program stored in the ROM 302. A control program and various kinds of applications run on the OS. The RAM 303 serves as a temporary storage area such as the main memory or work area of the CPU 301. The RAM 303 is also used as a temporary storage area for image processing.

The interface control unit 305 controls a network I/F such as the NIC (Network Interface Card) 306 to send/receive various data such as image data to/from a network such as a LAN. The operation I/F 308 inputs a user's operation instruction from the operation unit 307 such as a hard key or a remote controller. The operation I/F 308 also controls the display unit 310 to display an operation window on the screen 130.

The rendering unit 309 generates bitmap data representing a display image. Note that the rendering unit 309 interprets display list data received via the NIC 306, thereby generating bitmap data. The display unit 310 irradiates the screen 130 with the bitmap data generated by the rendering unit 309.

According to the embodiment, data to be input to the projector 120 include print data from the PC 140 and print data the scanner unit 214 of the printing apparatus 100 or 110 reads from an original. These print data are first stored in a storage device (RAM 203 or mass storage 206) in the printing apparatus 100 or 110. The printing apparatus 100 or 110 creates a display list in accordance with a print condition to print the print data on a paper sheet or a display request from the projector.

The above-described print data from the PC 140 is intermediate data obtained by interpreting a PDL (Page Description Language) sent from the PC 140. The print data from the scanner unit 214 is intermediate data generated by receiving, via the scanner I/F 213, image data read by the scanner unit 214, causing the scanner image processing unit 212 to divide the image data into attributes such as character, photo, table, and line image, and converting the data into a format common to intermediate data, i.e., image data from the PC 140.

<Display List Generation Method>

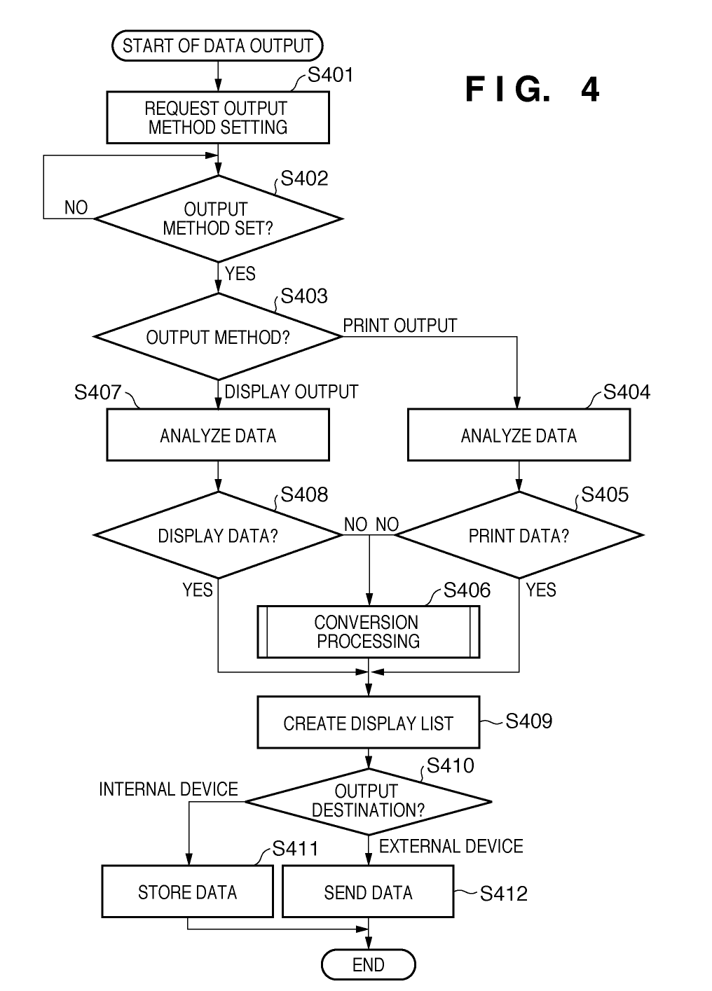

A display list generation method of this embodiment will be described next with reference to FIG. 4. FIG. 4 is a flowchart illustrating a display list data generation procedure according to the first embodiment. This flowchart assumes that an output request is sent to the printing apparatus 100. Hence, the processing that is explained below is comprehensively controlled by the CPU 201 of the printing apparatus 100.

In step S401, the CPU 201 receives an output request, and sends an output method setting request to the apparatus (in this case, the PC 140) of the output request sending destination. Output methods include, for example, print output and display output. In step S402, the CPU 201 determines whether the output method setting has been executed. If the output method has been set, the process advances to step S403. If no method has been set, the determination in step S402 is periodically repeated.

When the output method has been set, the CPU 201 determines the set output method in step S403. If the output method is print output, the process advances to step S404. If the output method is display output, the process advances to step S407.

When the output method is print output, the CPU 201 analyzes, in step S404, data received from the PC 140 via the interface control unit 207 and stored in the storage device (e.g., RAM 203 or mass storage 206). Alternatively, the CPU 201 analyzes data received from the scanner unit 214 and stored in the storage device. The CPU 201 analyzes whether the data stored in the storage device is print data.

In step S405, the CPU 201 determines based on the analysis result whether the data stored in the storage device is print data. If the stored data is print data, the process advances to step S409. If the data is not print data, the process advances to step S406.

When the stored data is print data, the CPU 201 generates a display list from the stored print data in step S409. In step 410, the CPU 201 determines the output destination. The CPU 201 determines here whether the output destination of the generated display list is an internal device (printer unit 217) or an external device (projector 120). For an internal device, the CPU 201 advances to step S411 to store the display list in the storage device. For an external device, the CPU 201 advances to step S412 to send the display list via the interface control unit 207.

On the other hand, upon determining in step S405 that the stored data is not print data, the CPU 201 converts the stored data into print data in step S406. The CPU 201 then executes the above-described processes in steps S409 to 5412 using the converted print data.

Upon determining in step S403 that the set output method is display output, the process advances to step 407. The CPU 201 analyzes data received from the PC 140 via the interface control unit 207 and stored in the storage device. Alternatively, the CPU 201 analyzes data received from the scanner unit 214 and stored in the storage device. More specifically, the CPU 201 analyzes whether the data stored in the storage device is display data.

In step S408, the CPU 201 determines based on the analysis result whether the data stored in the storage device is display data. If the stored data is display data, the process advances to step S409. If the data is not display data, the process advances to step S406. The process from step S406 to 5409 is the same as the above-described process executed when the output method is print output, and a description thereof will not be repeated.

<Display Control to Projector>

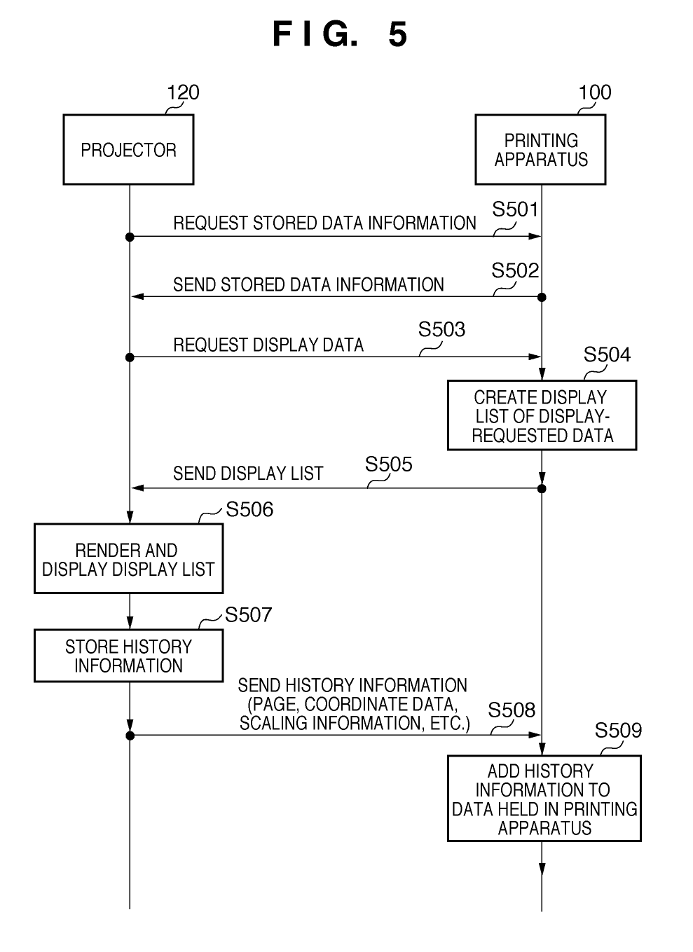

Display control from the printing apparatus 100 to the projector 120 will be described next with reference to FIG. 5. FIG. 5 is a sequence chart showing communication between the printing apparatus 100 and the projector 120 according to the first embodiment. As shown in FIG. 1, the printing apparatus 100 and the projector 120 are connected via the LAN 150 to transfer data between them.

First in step S501, the projector 120 sends a storage data information request to the printing apparatus 100. More specifically, the user who makes a presentation directly designates a file or searches for a file based on a keyword using a remote controller dedicated to the projector or the operation unit of the projector, thereby requesting storage data information. The storage data information need not always contain a single file but may include a list of a plurality of files.

In step S502, the printing apparatus 100 sends the storage data information to the projector 120. More specifically, the printing apparatus 100 sends the file name or file list designated by the user. The projector 120 then displays, on the screen of the operation unit of the projector or on the screen 130 on which the projector is projecting data, the file name or file list as a text or thumbnail. The user confirms the file name or file list displayed on the screen 130 and selects a file to be displayed by the projector 120 using the remote controller dedicated to the projector or the operation unit of the projector. After selection by the user, the projector 120 sends a display data request to the printing apparatus 100 in step S503.

Upon receiving the display data request from the projector 120, the printing apparatus 100 executes processing of generating a display list of the display-requested data in step S504. At this time, an optimum display list is generated in accordance with the output device that displays the data, as described with reference to FIG. 4. In this example, the data is sent to the projector 120. Hence, the output method is display output, and the display list of display data is generated. After generating the display list, the printing apparatus 100 sends it to the projector 120 in step S505.

Upon receiving the display list, the rendering unit 309 of the projector 120 bitmaps it and sends the bitmapped display list to the display unit 310 in step S506. The display unit 310 projects the image onto the screen 130 in accordance with the data of the display list.

The user makes a presentation while a display image is being displayed in accordance with the presentation data projected onto the screen 130. For a more effective presentation, the user sometimes makes an explanation using the remote controller dedicated to the projector or the operation unit of the projector. For example, the user may manipulate the pointer to point an emphasis target point or instruct enlargement rendering of an emphasis target point. At this time, in step S507, the projector 120 temporarily stores the pointer movement and its coordinates, command information for, e.g., enlargement rendering, page information under rendering, and the like in, e.g., the internal RAM 303 as the above-described history information of predetermined operations. Note that for enlargement rendering of a specific portion under rendering, the display list is preferably re-rendered. With the re-rendering, the rendering quality is expected to be higher than that of simple enlargement rendering of bitmap data.

When the user has ended the presentation, the projector 120 sends, in step S508, the history information temporarily stored in the RAM 303 to the printing apparatus 100. Upon receiving the history information, the printing apparatus 100 adds it to corresponding stored data in step S509. The stored data indicates the display data sent to the projector 120. At this time, the history information can be either added directly to the stored data or held independently of the stored data. Note that to separately hold the stored data and the history information, it is necessary to manage the stored data and the history information in association with each other.

An example has been described here in which defining a presentation as one job, display data request, display list sending, and history information sending are controlled for each job. However, the unit need not always be a job. For example, the control may be done for each page depending on the scale of the hardware or system of the projector 120. Alternatively, defining one page as the unit, the control may be performed for a plurality of pages. Otherwise, defining one job as the unit, the control may be done not for each job but for a plurality of jobs. The composition can be changed as needed depending on the scale of the hardware or system.

<History Information Acquisition Method>

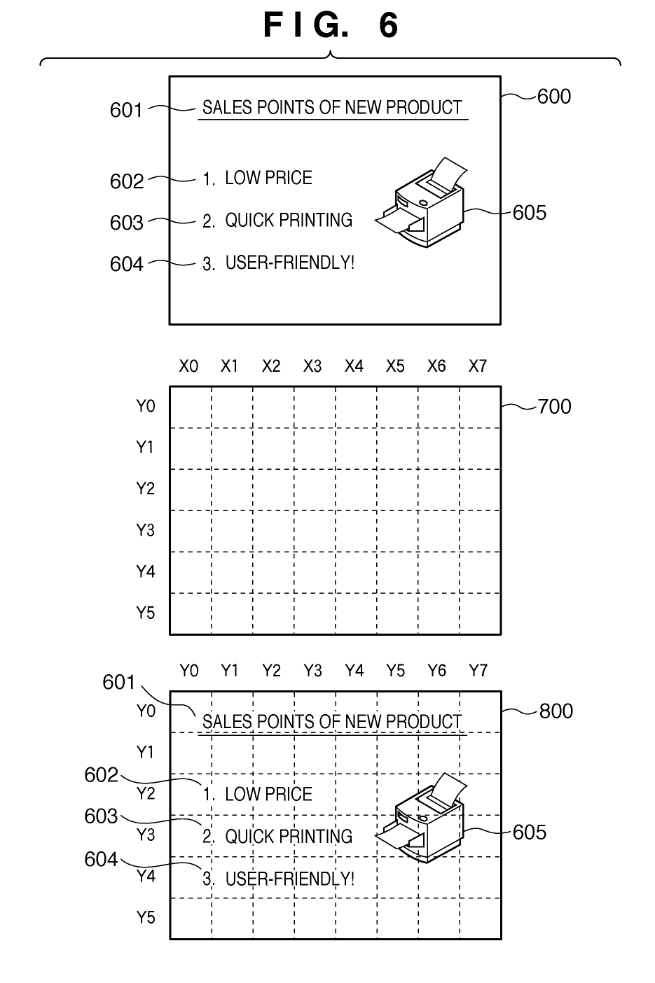

A history information acquisition method of the embodiment will be described next with reference to FIG. 6. FIG. 6 is a view showing a display image 600 obtained by outputting display data according to the first embodiment.

Display data rendered by the rendering unit 309 of the projector 120 is sent to the display unit 310 by the CPU 301 and projected onto the screen 130. The user makes a presentation using the display image 600 projected on the screen 130. At this time, the user causes a pointer to point an emphasis target point or instructs enlargement rendering using the remote controller dedicated to the projector or the operation unit of the projector. The CPU 301 specifies such an operation as an emphasizing operation and stores the history information of the emphasizing operation.

The display image 600 in FIG. 6 indicates a predetermined page of the display image, and includes character objects such as a title 601 and texts 602, 603, and 604 and image objects such as an image 605. Assume that the user makes a presentation using the display image 600 while emphasizing the text 604, i.e., the user points near the text to be emphasized using a remote-controlled pointer. In this case, the pointer is rendered on the display image 600 and projected and displayed on the screen 130 together with the display image 600.

At this time, if, for example, the pointer is displayed a predetermined number of times or more in a predetermined display area, the CPU 301 specifies it as an emphasizing operation using the pointer. That is, the CPU 301 specifies the emphasizing operation based on the pointer display frequency in the predetermined display area. Upon specifying the emphasizing operation of the pointer, the CPU 301 temporarily stores, in the RAM 303, the type of the emphasizing operation and the information of the display area where the pointer has been manipulated. The type of the emphasizing operation indicates the user operation used for the emphasizing operation, i.e., the pointer manipulation in this case. Note that the CPU 301 may either store all pointer loci or acquire only the emphasized display area.

A coordinate block 700 shown in FIG. 6 is divided into eight parts X0 to X7 in the horizontal direction and six parts Y0 to Y5 in the vertical direction. The number of divided parts is merely an example and is not limited. That is, in accordance with the use purpose, the number of divided parts may be increased to attain a higher accuracy or decreased to reduce the process load.

When the coordinate block 700 is superimposed on the display image 600, as indicated by 800 in FIG. 6, the text 604 emphasized by the user can be specified by coordinate blocks. More specifically, the CPU 301 specifies that the text 604 is rendered in an area including X0 to X4 in the horizontal direction and Y4 in the vertical direction. That is, the CPU 301 temporarily stores, as history information in the RAM 303, the operation of manipulating the pointer and the coordinate blocks in which the pointer has moved. Note that according to the present invention, the position acquisition method is not limited to this, and for example, pixel positions corresponding to the number of rendered pixels may be used.

A method of acquiring an area emphasized by another emphasizing operation by the user will be described. Assume that the user executes enlargement rendering of the image 605 and, more specifically, the user points part of the rendered portion using the remote-controlled pointer and inputs an enlargement command to perform enlargement rendering of a partial area in the display image 600. At this time, the CPU 301 specifies an emphasizing operation of enlargement rendering based on the operator's input via the operation unit 307 or the remote controller, for example, when an enlargement command has been input. Upon specifying the emphasizing operation of enlargement rendering, the CPU 301 temporarily stores, in the RAM 303, the type of the emphasizing operation and the information of the display area that has undergone enlargement rendering. The information of the display area indicates, based on the coordinate block 700, that the enlarged image area includes X5 and X6 in the horizontal direction and Y2 and Y3 in the vertical direction. That is, the CPU 301 temporarily stores, as history information in the RAM 303, the enlargement rendering operation and the coordinate blocks of the area that has undergone the enlargement rendering.

What kind of operation in the display image 600 should be specified as an emphasizing operation can be defined in advance. For example, presetting may be done to specify an operation as an emphasizing operation based on the pointing time or overlap (frequency) of the pointer in a given display area, as described above. Alternatively, presetting may be done to specify an operation instruction input via the remote controller or the operation unit 307 as an emphasizing operation together with the command. Upon detecting such an operation, the CPU 301 specifies, using the coordinate block 700, the display area where the operation has been performed.

The history information temporarily stored in the RAM 303 is transferred to the printing apparatus 100 at a predetermined timing in accordance with the communication between the projector 120 and the printing apparatus 100 described with reference to FIG. 5, and held in the RAM 203 or mass storage 206 of the printing apparatus 100.

<Digest Version Creation Method>

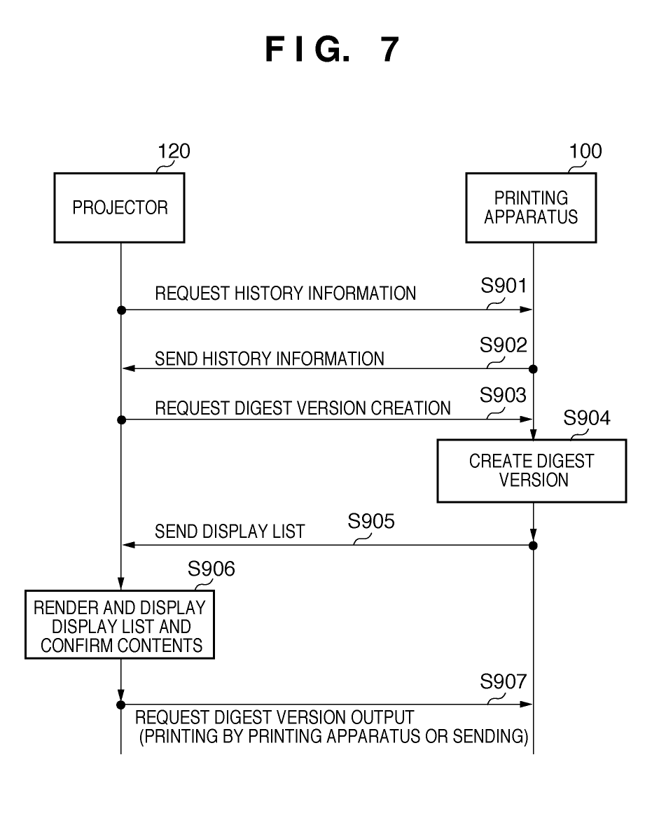

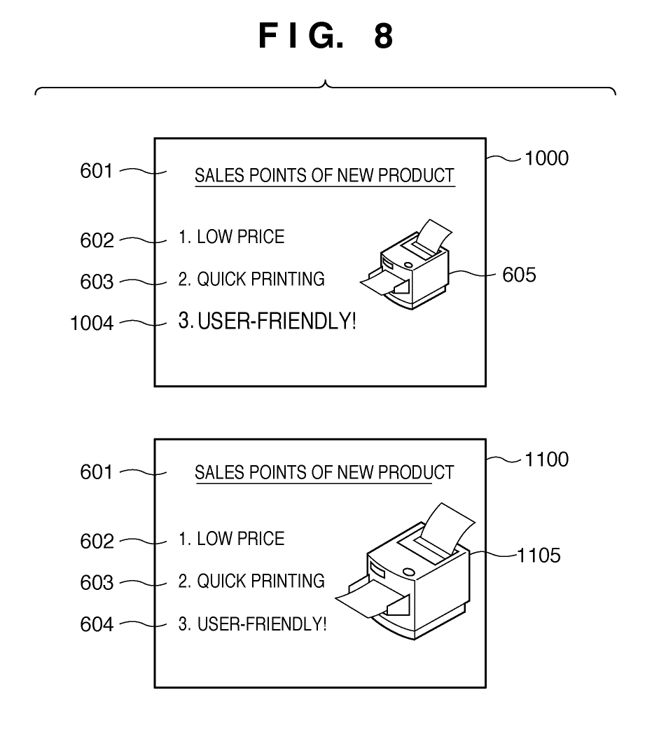

A digest data (digest version) creation method according to this embodiment will be described next with reference to FIGS. 7 and 8. FIG. 7 is a sequence chart showing the procedure of creating digest data of a presentation according to the first embodiment. The term “digest version” originally indicates content or the like containing only main points. However, the embodiment is not limited to this. Not the digest version of a material in a presentation but the digest version of the presentation including predetermined operations performed by the operator during the presentation is created here. The present invention is not limited to this, as a matter of course. The digest version of a material itself may be created, like a general digest version.

In step S901, the projector 120 sends a stored history information request to the printing apparatus 100. Stored history information indicates the above-described history information acquired at the time of a presentation, and includes operations based on user operations, operation instruction commands, and position information thereof during the presentation.

In step S902, the printing apparatus 100 sends the stored history information to the projector 120. Upon receiving the stored history information, the projector 120 displays the stored history information on the screen 130 via the operation unit 307 or the display unit 310. By referring to the history information, the user inputs a digest version creation instruction using the operation unit or remote controller via display on the screen 130. Upon receiving the user instruction, the projector 120 sends a digest version creation request to the printing apparatus 100 in step S903.

Upon receiving the digest version creation request, the printing apparatus 100 creates digest data in step S904 using display data used for the presentation and history information acquired at the time of presentation. The created digest data will be explained later with reference to FIG. 8.

In step S905, the printing apparatus 100 causes the CPU 201 to convert the created digest data into a display list, and sends the data to the projector 120. Note that the display list generation is the same as the method described with reference to FIG. 4, and a description thereof will not be repeated.

Upon receiving the display list, the projector 120 causes the rendering unit 309 to render it and send the result to the display unit 310, thereby displaying the data on the screen 130 in step S906. The user confirms the digest version displayed on the screen 130 and instructs to correct it as needed. Without any problem, the user instructs to output the digest version.

Upon receiving the user instruction, the projector 120 sends a digest version output request to the printing apparatus 100 in step S907. The output request includes, for example, a request to cause the printing apparatus 100 to print the digest version or a request to send the digest version to an external apparatus connected via the LAN 150. Hence, the printing apparatus 100 executes digest version print processing or send processing in accordance with the contents of the instruction.

For print processing, the CPU 201 of the printing apparatus 100 generates the display list of the digest version that is print data, and causes the rendering unit 218 to execute rendering processing. After that, the printer image processing unit 215 executes printer image processing, and the printer unit 217 outputs the data via the printer I/F 216. The number of copies to be output and the format can comply with predetermined initial settings or a user instruction added to the digest version output request.

Note that when generating the digest version, since the printing apparatus 100 holds presentation data as a PDL, digest version generation and emphasis processing such as coloration can easily be implemented.

For send processing, the CPU 201 generates a display list and causes the rendering unit 218 to render it. After that, the CPU 201 converts the data into, e.g., PDF and sends it to a predetermined destination via the interface control unit 207, NIC 208, and LAN 150. The destination can comply with predetermined initial settings or can be instructed by the user when outputting the digest version output request. Note that the file format for sending need not always be PDF. An image file such as TIFF or JPEG, or XPS (XML Paper Specification) is also usable.

FIG. 8 is a view showing digest images 1000 and 1100 of a presentation according to the first embodiment. The digest image 1000 shown in FIG. 8 is a digest version created based on an emphasizing operation using the pointer. More specifically, the digest image 1000 includes the display image 600 and an operation when the display image 600 has been presented. The same reference numerals as in the display image 600 denote the same display contents, and a description thereof will not be repeated.

The display image 600 will be compared with the digest image 1000. The text 604 emphasized at the time of presentation is displayed as a text 1004 in larger bold letters in the digest image 1000. This display control enables to reflect the area emphasized by the user in the presentation on the digest version. Note that display control of displaying characters in bold type or in larger size has been described above as an emphasizing method. However, the present invention is not limited to this, and a generally used emphasizing method such as coloration, box drawing, italicization, or highlighting may be used.

The digest image 1100 shown in FIG. 8 is a digest version created based on an emphasizing operation of enlargement rendering. More specifically, the digest image 1100 includes the display image 600 and an operation when the display image 600 has been presented. The same reference numerals as in the display image 600 denote the same display contents, and a description thereof will not be repeated.

The display image 600 will be compared with the digest image 1100. The image 605 emphasized by enlargement rendering at the time of presentation is displayed as an enlarged image 1105 in the digest image 1100. This display control enables to reflect the area emphasized by the user in the presentation on the digest version. Note that display control of enlarging the display size has been described above as an emphasizing method. However, the present invention is not limited to this, and a generally used emphasizing method such as box drawing, coloration, or background highlighting may be used.

Note that the digest version creation need not always be requested by the projector 120, as described above. For example, the operation unit 211 of the printing apparatus 100 or the PC 140 may instruct digest version creation.

As described above, the image processing system according to this embodiment stores, as history information, user operations such as pointer manipulation and an enlargement rendering operation at the time of presentation on the projector serving as a display apparatus together with the operation target display area. The printing apparatus serving as an image processing apparatus creates the digest data of the presentation using the history information and display data used for the presentation. Hence, the image processing system can create digest data including emphasizing operations by the operator during the presentation without shooting the operator's presentation by a video camera or the like.

Note that the present invention is not limited to the above-described embodiment, and various changes and modifications can be made. For example, the display apparatus may use coordinate data in a display image as information representing the display area of an emphasizing operation. This allows the image processing system to easily specify the display area as the target of an emphasizing operation.

Use of a printing apparatus having a sending function enables not only digest version printing but also distribution to another apparatus. In addition, the image processing system can use, as the display apparatus, not only a projector but also an apparatus for displaying an image on a monitor or the like.

### Second Embodiment

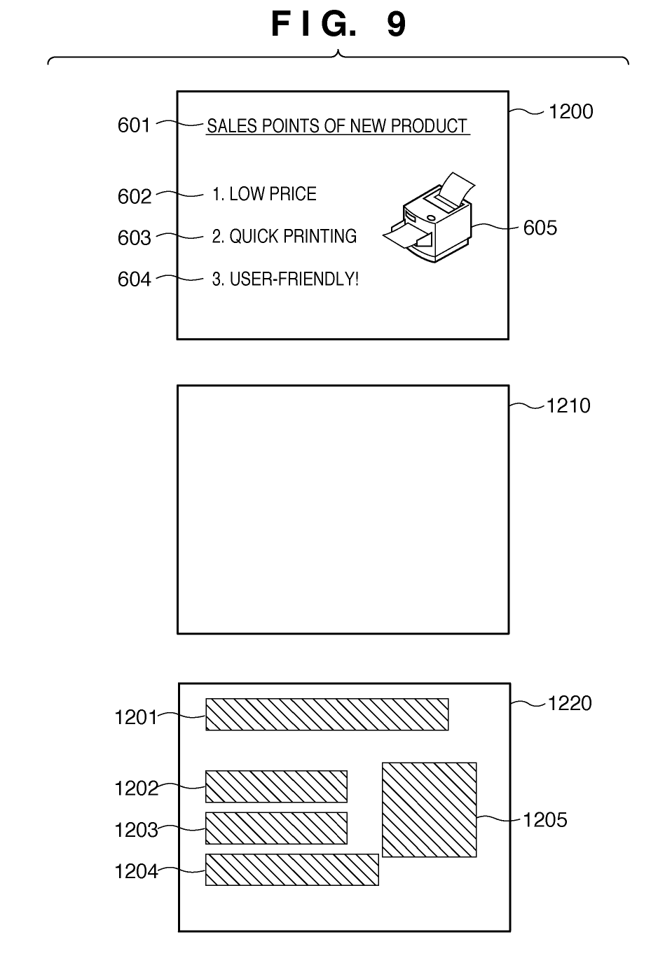

The second embodiment will be described next with reference to FIG. 9. In the second embodiment, when acquiring history information (detecting an emphasizing operation), an emphasizing operation is detected based on the difference in the display image before and after rendering, unlike the first embodiment. Note that only a technique different from the first embodiment will be explained here. That is, arrangements other than the technique to be described below are the same as in the first embodiment. FIG. 9 is a view showing the structure of a display image according to the second embodiment.

A display image 600 in FIG. 9 includes an image 1200 and an image 1210. The image 1200 is obtained by causing a rendering unit 309 of a projector 120 to render a display list. The image 1210 is displayed on a screen 130 to perform a file operation or setting operation from an operation unit 307. Hence, the display image 600 is displayed by overwriting the image 1210 on the image 1200.

Hence, when the user emphasizes an image by pointing it using a pointer during the presentation, it is difficult to detect the emphasizing operation by direct comparison with the image 1200 because the pointer is rendered on the image 1210. According to this embodiment, an outer frame image 1220 in which the outer frames of character objects and image objects arranged on the rendered image 1200 are defined is created. At this time, the outer frame image 1220 need not be held as an image. It is necessary to only hold the rectangle coordinates of pieces of rectangle information 1201, 1202, 1203, 1204, and 1205.

Using the rectangle coordinates, a CPU 301 specifies an emphasizing operation based on the pointer display frequency within the rectangle coordinates (in a display area corresponding to an outer frame image).

For example, when the pointer is displayed by the user operation beyond a predetermined time or count (frequency) within the rectangle information 1204, the CPU 301 specifies the operation as an emphasizing operation, and recognizes that the emphasizing operation has been done for a text 604 corresponding to the rectangle information 1204. That is, in this embodiment, an area where an emphasizing operation has been performed by the user is specified as a character object or an image object included in the image displayed by the projector 120. The CPU 301 temporarily stores, as history information in a RAM 303, the type of the emphasizing operation and the information (rectangle information) of an outer frame image representing the display area as the target of the emphasizing operation.

As described above, the image processing system according to this embodiment specifies, using the rectangle information (outer frame image information) of each object included in a display image, a display area where a predetermined operation has been executed. For example, if an emphasizing operation is pointer manipulation, it is specified based on the pointer display frequency in a display area corresponding to the rectangle information. Specifying an emphasizing operation using the rectangle information of each object enables to easily specify the object for which the emphasizing operation has been performed. It is therefore possible to generate more accurate history information.

### Third Embodiment

The third embodiment will be described next. In the above-described first and second embodiments, the pointer is overwritten on a rendered image using, e.g., the remote controller of the projector. However, in some cases, the user makes a presentation using a laser pointer or the like. In this case, it may be impossible to acquire the history information of an emphasized area from a rendered image. In this embodiment, a method of coping with the case in which the user uses a laser pointer or the like for pointing will be described. Note that only a technique different from the first embodiment will be explained here. Arrangements other than the technique to be described below are the same as in the first embodiment.

A recent projector has functions to make a projected image easily visible. For example, the projector has a function of detecting the color of a wall or screen, converting it into an optimum color temperature, and then projecting an image. The projector also has a function of detecting a tilt not to distort a projected image on a tilted wall or screen. To implement these functions, the projector has a detection sensor configured to detect the color and tilt of the projection target wall or screen in addition to the projection optical system.

In this embodiment, the generation frequency and generation position of data detected by the detection sensor from projection of a display image up to projection of the next display image are calculated. More specifically, the projector according to this embodiment detects, using the detection sensor, the irradiation time or irradiation position of a pointer irradiated by a laser pointer. Hence, the projector specifies an emphasizing operation during a presentation based on the detection result and acquires history information.

As described above, even when the operator makes a presentation using a laser pointer, the image processing system can grasp the irradiation time and position of the laser pointer using the detection sensor and generate history information as in the above-described embodiments.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-039833 filed on Feb. 23, 2009, which is hereby incorporated by reference herein in its entirety.

What is claimed is:

1. An image processing system formed by connecting a display apparatus to an image processing apparatus,
the display apparatus comprising:
a display unit that receives display data sent from the image processing apparatus and displays a display image based on the display data;
a specifying unit that specifies an operation to the display apparatus performed by an operator during display of the display image; and
a storage unit that stores history information representing a history of the specified operation, and
the image processing apparatus comprising:
a generation unit that generates the display data to be sent to the display apparatus; and
a memory unit that, after the generated display data has been sent to the display apparatus, receives the history information from the display apparatus and memorizes the received history information in correspondence with the generated display data.

2. The system according to claim 1, wherein the image processing apparatus further comprises a creation unit that creates, using the generated display data and the memorized history information, digest data of a presentation made by the operator.

3. The system according to claim 1, wherein
when the operation by the operator is an operation of a pointer displayed on the display image, said specifying unit specifies the operation based on a frequency of display of the pointer in a predetermined display area, and
when the operation by the operator is an operation of enlargement rendering of a partial image included in the display image, said specifying unit specifies the operation based on input for the enlargement rendering by the operator.

4. The system according to claim 3, wherein said storage unit stores, as the history information, a type of the specified operation and coordinate data representing a display area serving as a target of the specified operation in the display image.

5. The system according to claim 1, wherein
the display apparatus further comprises a unit that generates an outer frame image that defines an outer frame of a display area of a character object or an image object included in the display image,
when the operation by an operator is an operation of a pointer displayed on the display image, said specifying unit specifies the operation based on a frequency of display of the pointer in a display area corresponding to the outer frame image, and
when the operation by the operator is an operation of enlargement rendering of a partial image included in the display image, said specifying unit specifies the operation based on input for the enlargement rendering by the operator.

6. The system according to claim 5, wherein said storage unit stores, as the history information, a type of the specified operation and information of the outer frame image representing a display area serving as a target of the specified operation.

7. The system according to claim 2, wherein
the display apparatus further comprises a request unit that requests the image processing apparatus to create the digest data, and
said creation unit creates the display data when said request unit has requested to create the digest data.

8. The system according to claim 2, wherein said creation unit creates the display data by emphasizing and displaying an area where the specified operation has been performed.

9. The system according to claim 2, wherein the image processing apparatus further comprises an output unit that prints the digest data created by said creation unit on a printing material or sends the digest data to an external apparatus connected via a network.

10. The system according to claim 1, wherein the display apparatus is a projector that projects the display image in accordance with the display data.

11. The system according to claim 10, wherein
the display apparatus further comprises a detection unit that detects a time and position of irradiation of a laser pointer, by the operator, on the projected display image, and
said specifying unit specifies the operation by the operator based on a detection result of said detection unit.

12. An image processing apparatus connected to a display apparatus, comprising:
a generation unit that generates display data to be sent to the display apparatus; and
a creation unit that receives, from the display apparatus, history information representing a history of an operation to the display apparatus performed by an operator during display of a display image displayed by the display apparatus based on the display data, and creates, using the display data and the history information, digest data of a presentation made by the operator using the display image.

13. A display apparatus connected to an image processing apparatus, comprising:
a display unit that receives display data sent from the image processing apparatus and displays a display image based on the display data;
a specifying unit that specifies an operation to the display apparatus performed by an operator during display of the display image; and
a sending unit that sends, to the image processing apparatus, history information representing a history of the specified operation.

14. A method of controlling an image processing system formed by connecting a display apparatus to an image processing apparatus, comprising:
causing the display apparatus to execute
receiving display data sent from the image processing apparatus and displaying a display image based on the display data,
specifying an operation to the display apparatus performed by an operator during display of the display image, and
storing history information representing a history of the specified operation; and
causing the image processing apparatus to execute
generating the display data to be sent to the display apparatus, and
after the generated display data has been sent to the display apparatus, receiving the history information from the display apparatus and memorizing the history information in correspondence with the generated display data.

15. A method of controlling an image processing apparatus connected to a display apparatus, comprising:
generating display data to be sent to the display apparatus; and
receiving, from the display apparatus, history information representing a history of an operation to the display apparatus performed by an operator during display of a display image displayed by the display apparatus based on the display data, and creating, using the display data and the history information, digest data of a presentation made by the operator using the display image.

16. A method of controlling a display apparatus connected to an image processing apparatus, comprising:
receiving display data sent from the image processing apparatus and displaying a display image based on the display data;
specifying an operation to the display apparatus performed by an operator during display of the display image; and
sending, to the image processing apparatus, history information representing a history of the specified predetermined operation.

17. A computer-readable storage medium storing a computer program which causes a computer to execute an image processing system control method of claim 14.

18. A computer-readable storage medium storing a computer program which causes a computer to execute an image processing apparatus control method of claim 15.

19. A computer-readable storage medium storing a computer program which causes a computer to execute a display apparatus control method of claim 16.
